(19) United States
(12) Patent Application Publication
(10) Pub. No.: US 2026/0260451 A1
(43) Pub. Date: Sep. 3, 2026

(54) SYSTEM AND METHOD FOR TASK SPECIFIC PROMPT GENERATION FOR FEW-SHOT SEGMENTATION WITH FOUNDATION MODELS

(71) Applicant: GE Precision Healthcare LLC, Waukesha, WI (US)

(72) Inventors: Gurunath Reddy Madhumani, Bangalore (IN); Deepa Anand, Bangalore (IN); Dattesh Dayanand Shanbhag, Bangalore (IN)

(21) Appl. No.: 19/066,683

(22) Filed: Feb. 28, 2025

(51) Int. Cl. G06V 10/26; G06V 10/25; G06V 10/74; G06V 10/762; G06V 20/70

(52) U.S. Cl. CPC G06V 10/26; G06V 10/25; G06V 10/761; G06V 10/762; G06V 20/70; G06V 2201/03

(57) ABSTRACT

A method includes obtaining an image of an object, inputting the image into a trained vision transformer model, and outputting from the trained vision transformer model pixel level feature vectors from the image. The method includes performing clustering on the pixel level feature vectors to generate different labeled coarse clustered regions, obtaining the image of the object with pixels labeled with an initial segmentation mask that corresponds to a region of interest in a template image, and identifying regions of overlap between the different labeled coarse clustered regions and the initial segmentation mask. The method includes automatically generating both positive prompts based on the regions of overlap and negative prompts based on those regions lacking overlap, wherein the positive prompt clusters and the negative prompt clusters are utilized in refining segmentation of a region in the image that corresponds to the region of interest in the template image.

### BACKGROUND

The subject matter disclosed herein relates to medical imaging and, more particularly, to a system and a method for task specific prompt generation for few-shot segmentation with foundation models.

Non-invasive imaging technologies allow images of the internal structures or features of a patient/object to be obtained without performing an invasive procedure on the patient/object. In particular, such non-invasive imaging technologies rely on various physical principles (such as the differential transmission of X-rays through a target volume, the reflection of acoustic waves within the volume, the paramagnetic properties of different tissues and materials within the volume, the breakdown of targeted radionuclides within the body, and so forth) to acquire data and to construct images or otherwise represent the observed internal features of the patient/object.

During MRI, when a substance such as human tissue is subjected to a uniform magnetic field (polarizing field B₀), the individual magnetic moments of the spins in the tissue attempt to align with this polarizing field, but precess about it in random order at their characteristic Larmor frequency. If the substance, or tissue, is subjected to a magnetic field (excitation field B₁) which is in the x-y plane and which is near the Larmor frequency, the net aligned moment, or “longitudinal magnetization”, M_{z}, may be rotated, or “tipped”, into the x-y plane to produce a net transverse magnetic moment, Mₜ. A signal is emitted by the excited spins after the excitation signal B₁ is terminated and this signal may be received and processed to form an image.

When utilizing these signals to produce images, magnetic field gradients (Gₓ, G_{y}, and G_{z}) are employed. Typically, the region to be imaged is scanned by a sequence of measurement cycles in which these gradient fields vary according to the particular localization method being used. The resulting set of received nuclear magnetic resonance (NMR) signals are digitized and processed to reconstruct the image using one of many well-known reconstruction techniques.

Localization and region interest segmentation needs are ubiquitous in different stages of a radiology workflow: planning, guidance, and lesion identification and measurement. However, localization is laborious and repetitive task. In addition, localization increases clinician fatigue which may lead to inaccuracy. Further, localization increases costs. Foundation models are attractive to automate localization needs given their excellent grounding capabilities demonstrated in natural images. However, previous attempts using grounding foundation models out of the box for radiology image localization have not been successful.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a computer-implemented method is provided. The computer-implemented method includes obtaining, via a processing system including one or more processors, an image of an object. The computer-implemented method also includes inputting, via the processing system, the image of the object into a trained vision transformer model. The computer-implemented method further includes outputting, via the processing system, from the trained vision transformer model pixel level feature vectors from the image of the object. The computer-implemented method further includes performing, via the processing system, clustering on the pixel level feature vectors to generate different labeled coarse clustered regions in the image of the object. The computer-implemented method further includes obtaining, via the processing system, the image of the object with pixels labeled with an initial segmentation mask that corresponds to a region of interest in a template image. The computer-implemented method even further includes identifying, via the processing system, regions of overlap between the different labeled coarse clustered regions and the initial segmentation mask. The computer-implemented method further includes automatically generating, via the processing system, both positive prompts based on the regions of overlap and negative prompts based on those regions lacking overlap, wherein the positive prompt clusters and the negative prompt clusters are utilized in refining segmentation of a region in the image of the object that corresponds to the region of interest in the template image.

In another embodiment, a system for performing one-shot anatomy localization is provided. The system includes a memory encoding processor-executable routines. The system also includes a processing system including one or more processors and configured to access the memory and to execute the processor-executable routines, wherein the routines, when executed by the processing system, cause the processing system to perform actions. The actions include obtaining an image of an object. The actions also include inputting the image of the object into a trained vision transformer model. The actions further include outputting from the trained vision transformer model pixel level feature vectors from the image of the object. The actions even further include performing clustering on the pixel level feature vectors to generate different labeled coarse clustered regions in the image of the object. The actions further include obtaining the image of the object with pixels labeled with an initial segmentation mask that corresponds to a region of interest in a template image. The actions even further include identifying regions of overlap between the different labeled coarse clustered regions and the initial segmentation mask. The actions further include automatically generating both positive prompts based on the regions of overlap and negative prompts based on those regions lacking overlap, wherein the positive prompt clusters and the negative prompt clusters are utilized in refining segmentation of a region in the image of the object that corresponds to the region of interest in the template image.

In a further embodiment, a non-transitory computer-readable medium is provided. The non-transitory computer-readable medium includes processor-executable code that, when executed by a processing system including one or more processors, causes the processing system to perform actions. The actions include obtaining an image of an object. The actions also include inputting the image of the object into a trained vision transformer model. The actions further include outputting from the trained vision transformer model pixel level feature vectors from the image of the object. The actions even further include performing clustering on the pixel level feature vectors to generate different labeled coarse clustered regions in the image of the object. The actions further include obtaining the image of the object with pixels labeled with an initial segmentation mask that corresponds to a region of interest in a template image. The actions even further include identifying regions of overlap between the different labeled coarse clustered regions and the initial segmentation mask. The actions further include automatically generating both positive prompts based on the regions of overlap and negative prompts based on those regions lacking overlap, wherein the positive prompt clusters and the negative prompt clusters are utilized in refining segmentation of a region in the image of the object that corresponds to the region of interest in the template image.

### BRIEF DESCRIPTION OF THE DRAWINGS

These and other features, aspects, and advantages of the present subject matter will become better understood when the following detailed description is read with reference to the accompanying drawings in which like characters represent like parts throughout the drawings, wherein:

FIG. 1 illustrates an embodiment of a magnetic resonance imaging (MRI) system suitable for use with the disclosed technique;

FIG. 2 illustrates a schematic diagram of training of a contrastive similarity metric learning model for localization, in accordance with aspects of the present disclosure;

FIG. 3 illustrates a schematic diagram for data adaptive single-shot segmentation with foundation models;

FIG. 4 illustrates outcome of utilizing data adaptive single-shot segmentation with foundation models;

FIG. 5 illustrates outcome of utilizing randomly chosen negative prompts;

FIG. 6 illustrates a schematic diagram for task specific prompt generation for few-shot segmentation with foundation models, in accordance with aspects of the present disclosure;

FIG. 7 illustrates a flow diagram of a method for performing task specific prompt generation for few-shot segmentation with foundation models, in accordance with aspects of the present disclosure;

FIG. 8 illustrates a flow diagram of a method for obtaining an image of the object with pixels labeled with an initial segmentation mask that corresponds to a region of interest in a template image, in accordance with aspects of the present disclosure;

FIG. 9 depicts results of utilizing the method in FIG. 7, in accordance with aspects of the present disclosure; and

FIG. 10 depicts MR images of a shoulder utilizing different segmentation approaches, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While aspects of the following discussion are provided in the context of medical imaging, it should be appreciated that the disclosed techniques are not limited to such medical contexts. Indeed, the provision of examples and explanations in such a medical context is only to facilitate explanation by providing instances of real-world implementations and applications. However, the disclosed techniques may also be utilized in other contexts, such as image reconstruction for non-destructive inspection of manufactured parts or goods (i.e., quality control or quality review applications), and/or the non-invasive inspection of packages, boxes, luggage, and so forth (i.e., security or screening applications). In general, the disclosed techniques may be useful in any imaging or screening context or image processing or photography field where a set or type of acquired data undergoes a reconstruction process to generate an image or volume.

Deep-learning (DL) approaches discussed herein may be based on artificial neural networks, and may therefore encompass one or more of deep neural networks, fully connected networks, convolutional neural networks (CNNs), unrolled neural networks, perceptrons, encoders-decoders, recurrent networks, wavelet filter banks, u-nets, general adversarial networks (GANs), dense neural networks, or other neural network architectures. The neural networks may include shortcuts, activations, batch-normalization layers, and/or other features. These techniques are referred to herein as DL techniques, though this terminology may also be used specifically in reference to the use of deep neural networks, which is a neural network having a plurality of layers.

One type of deep learning model is a vision transformer model. A vision transformer model utilizes transformers (e.g., vision transformers) for image recognition tasks. In particular, a vision transformer model breaks down an input image (e.g., medical image) into patches, processes these patches using transformers, and aggregates the information for classification or object detection. A vision transformer model utilizes self-attention (i.e., a global operation) since it draws information from the whole image. This enables the vision transformer model to capture distinct semantic relevancies in an image effectively. Vision transformer models obtain similar or better results than other types of deep learning models (e.g., convolutional networks) while requiring substantially fewer computational resources to train.

As discussed herein, DL techniques (which may also be known as deep machine learning, hierarchical learning, or deep structured learning) are a branch of machine learning techniques that employ mathematical representations of data and artificial neural networks for learning and processing such representations. By way of example, DL approaches may be characterized by their use of one or more algorithms to extract or model high level abstractions of a type of data-of-interest. This may be accomplished using one or more processing layers, with each layer typically corresponding to a different level of abstraction and, therefore potentially employing or utilizing different aspects of the initial data or outputs of a preceding layer (i.e., a hierarchy or cascade of layers) as the target of the processes or algorithms of a given layer. In an image processing or reconstruction context, this may be characterized as different layers corresponding to the different feature levels or resolution in the data. In general, the processing from one representation space to the next-level representation space can be considered as one ‘stage’ of the process. Each stage of the process can be performed by separate neural networks or by different parts of one larger neural network.

Previously, chain foundation models (deeper into neural networks (DINO) and segment anything model (SAM)) were utilized to provide segmentation capabilities with very few labeled templates. In particular, the DINO provides localization using a few template images. These template images were used to train a contrastive model to account for MR protocol variations and to provide accurate region localization on any new test image. The DINO-based localization provides positive prompts (i.e., prompt located in region of interest) to the cascading SAM as a region growing seed and refines the segmentation. However, the issue with this approach is that the segmentation leaks when an object of interest has different boundaries with matching intensities. Use of negative prompts (i.e., prompt outside region of interest) with SAM can resolve this but there is a need to automate this step.

Using a template for negative prompts is not feasible since the outside region can vary based on tissue types, field of view (FOV) factor, etc., while the positive prompt region is always constant. Placing random negative prompts results in under segmentation since the region of interest (ROI) is not completely segregated in DINO localization. Hence, the ability to automate negative prompt generation is critical for robust performance especially in MR images with rich but varying soft tissue contrast.

The present disclosure provides systems and methods for task specific prompt generation for few-shot segmentation with foundation models. In particular, a technique is provided to automate negative prompts generation for chained foundation model-based region segmentation. A user masks only a region of interest on one or more template images which are then used to automatically generate positive and negative prompts. In particular, the systems and methods use a combination of the DINO-predicted positive prompts with DINO-found model features-based image clustering to automatically generate the negative prompts to guide SAM-based segmentation. The disclosed systems and methods provide the ability to generate negative prompts at scale irrespective of image FOV and tissue or background changes. The disclosed systems and methods put the user in complete control since the user provides the region of interest on templates thereby reducing the risk of any false negatives (which is particularly important in use cases such as a lesion which can vary from disease to disease. The user does not have to specify negative or positive prompts. Rather, the user only changes the template per task, which is much easier than retraining new models per task. The disclosed systems and methods enable accurate segmentation to be derived using chained DINO and SAM.

In addition, a contrastive learning-based technique is utilized that allows for feature similarity to be driven using task data itself without the need for any manual tuning. Moreover, it allows for multiple tasks on the same data to be completed in a single instance, thereby enabling multi-label single shot localization and region of interest segmentation with foundation models to be utilized with medical imaging data (e.g., three-dimensional (3D) imaging data). A self-supervised model is trained on an unlabeled pool of data using a vision transformer (e.g., unsupervised vision transformer) as the backbone with the objective of deriving robust feature representations of images that are contextually dependent features. The vision transformer architecture enables deriving patch level features which can be extended to pixel level features (via simple postprocessing). In addition, a contrastive similarity metric learning model is trained on the pixel level features derived from the vision transformer to push similar features as close as possible and pushing dissimilar features as apart as possible. This is done by creating sample data for a task, augmenting them by simulating variations expected in real life scenarios for the task, creating pairs of positive and negative feature vectors for each of the multiple tasks, to account for the variability within the feature vectors, and generating a model. The application of this model for any new test data eliminates utilizing heuristic manual thresholding (e.g., previously utilized with localization attempts that utilized foundation models) by automatically finding the similarity between the feature vectors for localization. In particular, the contrastive similarity metric learning model performs the thresholding utilizing a data driven approach.

In addition, clustering is performed on the pixel level features (e.g., derived from a target image) to segregate different regions in the target image into labeled coarse clustered regions. Overlap between the coarse clustered regions and the localization output of the target image (derived from the contrastive similarity metric learning model) is determined (e.g., via Dice, intersection over union). Regions with zero (or almost zero) overlap are utilized to automatically generate negative prompts. The localization output serves as the source of the positive prompt. The positive and negative prompts are chained with a promptable foundation Segment Anything Model (SAM) segmentation model which performs a final segmentation (e.g., obtain finer segmentation region) on the target image.

The disclosed embodiments automatically enable accurate localization and segmentation using foundation models based on templates. Multiple tasks can be accomplished with a single foundation model (FM). The disclosed embodiments utilize the power of SAM-FM to complete the segmentation and achieves this by automatically providing positive and negative prompts based on a user's positive prompt input on few templates (e.g., N=5−10). No retraining of a SAM model is needed with the disclosed embodiments. The disclosed embodiments provides for faster and pointed annotation of medical imaging data (at a reduced cost).

The disclosed systems and methods include obtaining, via a processing system including one or more processors, an image of an object. The disclosed systems and methods also include inputting, via the processing system, the image of the object into a trained vision transformer model. The disclosed systems and methods further include outputting, via the processing system, from the trained vision transformer model pixel level feature vectors from the image of the object. The disclosed systems and methods further include performing, via the processing system, clustering on the pixel level feature vectors to generate different labeled coarse clustered regions in the image of the object. The disclosed systems and methods further include obtaining, via the processing system, the image of the object with pixels labeled with an initial segmentation mask that corresponds to a region of interest in a template image. The disclosed systems and methods even further include identifying, via the processing system, regions of overlap between the different labeled coarse clustered regions and the initial segmentation mask. The disclosed systems and methods further include automatically generating, via the processing system, both positive prompts based on the regions of overlap and negative prompts based on those regions lacking overlap, wherein the positive prompt clusters and the negative prompt clusters are utilized in refining segmentation of a region in the image of the object that corresponds to the region of interest in the template image.

In certain embodiments, the disclosed systems and methods include utilizing, via the processing system, a promptable segmentation model to label the image of the object with a refined segmentation mask of the region that corresponds to the region of interest in the template image based on the positive prompt clusters and the negative prompt clusters. In certain embodiments, the image of the object is a medical image of a portion a subject. In certain embodiments, identifying regions of overlap includes utilizing intersection over union. In certain embodiments, identifying the regions of overlap includes utilizing Dice similarity coefficients.

In certain embodiments, obtaining the image of the object with pixels labeled with the initial segmentation mask includes: receiving, via the processing system, a selection of both the template image and the region of interest within the template image, wherein the region of interest is marked in the template image and is associated with a label; inputting, via the processing system, the template image into the trained vision transformer model; outputting, via the processing system, from the trained vision transformer model a reference pixel level feature vector from the region of interest of the template image; inputting, via the processing system, both the pixel level feature vectors and the reference pixel level feature vector into a trained contrastive similarity metric learning model, wherein the trained contrastive similarity metric learning model is configured to automatically determine which of the pixel level feature vectors are similar to the reference pixel level feature vector; outputting, via the processing system, from the trained contrastive similarity metric learning model the pixels of the image of object that are similar to reference pixels; and labeling, via the processing system, the pixels in the image of the object associated with the pixel level feature vectors that are similar to the reference pixel level feature vector with the initial segmentation mask. In certain embodiments, labeling the pixels in the image of the object associated with the pixel level feature vectors that are similar to the reference pixel level feature vector includes utilizing connected component analysis on the pixels to generate the initial segmentation mask.

The disclosed techniques may be utilized for localization. In addition, the disclosed techniques may be utilized for longitudinal lesion tracking across multiple time points. The disclosed techniques may be utilized with different types of medical images. For example, the images may be obtained from MRI, computed tomography (CT) imaging, or other types of imaging systems. In the present disclosure, the techniques are described in the context of MRI. In certain embodiments, non-medical images may be utilized with the disclosed techniques (e.g., for industrial applications).

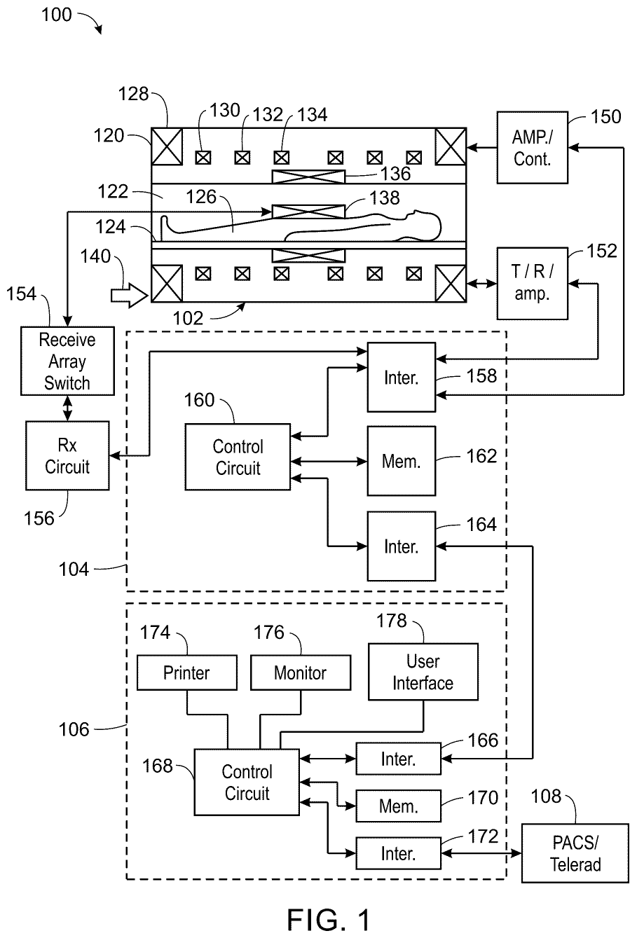

With the preceding in mind, FIG. 1 a magnetic resonance imaging (MRI) system 100 is illustrated schematically as including a scanner 102, scanner control circuitry 104, and system control circuitry 106. According to the embodiments described herein, the MRI system 100 is generally configured to perform MR imaging.

System 100 additionally includes remote access and storage systems or devices such as picture archiving and communication systems (PACS) 108, or other devices such as teleradiology equipment so that data acquired by the system 100 may be accessed on-or off-site. In this way, MR data may be acquired, followed by on-or off-site processing and evaluation. While the MRI system 100 may include any suitable scanner or detector, in the illustrated embodiment, the system 100 includes a full body scanner 102 having a housing 120 through which a bore 122 is formed. A table 124 is moveable into the bore 122 to permit a patient 126 (e.g., subject) to be positioned therein for imaging selected anatomy within the patient.

Scanner 102 includes a series of associated coils for producing controlled magnetic fields for exciting the gyromagnetic material within the anatomy of the patient being imaged. Specifically, a primary magnet coil 128 is provided for generating a primary magnetic field, B₀, which is generally aligned with the bore 122. A series of gradient coils 130, 132, and 134 permit controlled magnetic gradient fields to be generated for positional encoding of certain gyromagnetic nuclei within the patient 126 during examination sequences. A radio frequency (RF) coil 136 (e.g., RF transmit coil) is configured to generate radio frequency pulses for exciting the certain gyromagnetic nuclei within the patient. In addition to the coils that may be local to the scanner 102, the system 100 also includes a set of receiving coils or RF receiving coils 138 (e.g., an array of coils) configured for placement proximal (e.g., against) to the patient 126. As an example, the receiving coils 138 can include cervical/thoracic/lumbar (CTL) coils, head coils, single-sided spine coils, and so forth. Generally, the receiving coils 138 are placed close to or on top of the patient 126 so as to receive the weak RF signals (weak relative to the transmitted pulses generated by the scanner coils) that are generated by certain gyromagnetic nuclei within the patient 126 as they return to their relaxed state.

The various coils of system 100 are controlled by external circuitry to generate the desired field and pulses, and to read emissions from the gyromagnetic material in a controlled manner. In the illustrated embodiment, a main power supply 140 provides power to the primary field coil 128 to generate the primary magnetic field, Bo. A power input (e.g., power from a utility or grid), a power distribution unit (PDU), a power supply (PS), and a driver circuit 150 may together provide power to pulse the gradient field coils 130, 132, and 134. The driver circuit 150 may include amplification and control circuitry for supplying current to the coils as defined by digitized pulse sequences output by the scanner control circuitry 104.

Another control circuit 152 is provided for regulating operation of the RF coil 136. Circuit 152 includes a switching device for alternating between the active and inactive modes of operation, wherein the RF coil 136 transmits and does not transmit signals, respectively. Circuit 152 also includes amplification circuitry configured to generate the RF pulses. Similarly, the receiving coils 138 are connected to switch 154, which is capable of switching the receiving coils 138 between receiving and non-receiving modes. Thus, the receiving coils 138 resonate with the RF signals produced by relaxing gyromagnetic nuclei from within the patient 126 while in the receiving mode, and they do not resonate with RF energy from the transmitting coils (i.e., coil 136) so as to prevent undesirable operation while in the non-receiving mode. Additionally, a receiving circuit 156 is configured to receive the data detected by the receiving coils 138 and may include one or more multiplexing and/or amplification circuits.

It should be noted that while the scanner 102 and the control/amplification circuitry described above are illustrated as being coupled by a single line, many such lines may be present in an actual instantiation. For example, separate lines may be used for control, data communication, power transmission, and so on. Further, suitable hardware may be disposed along each type of line for the proper handling of the data and current/voltage. Indeed, various filters, digitizers, and processors may be disposed between the scanner and either or both of the scanner and system control circuitry 104, 106.

As illustrated, scanner control circuitry 104 includes an interface circuit 158, which outputs signals for driving the gradient field coils and the RF coil and for receiving the data representative of the magnetic resonance signals produced in examination sequences. The interface circuit 158 is coupled to a control and analysis circuit 160. The control and analysis circuit 160 executes the commands for driving the circuit 150 and circuit 152 based on defined protocols selected via system control circuit 106.

Control and analysis circuit 160 also serves to receive the magnetic resonance signals and performs subsequent processing before transmitting the data to system control circuit 106. Scanner control circuit 104 also includes one or more memory circuits 162, which store configuration parameters, pulse sequence descriptions, examination results, and so forth, during operation.

Interface circuit 164 is coupled to the control and analysis circuit 160 for exchanging data between scanner control circuitry 104 and system control circuitry 106. In certain embodiments, the control and analysis circuit 160, while illustrated as a single unit, may include one or more hardware devices. The system control circuit 106 includes an interface circuit 166, which receives data from the scanner control circuitry 104 and transmits data and commands back to the scanner control circuitry 104. The control and analysis circuit 168 may include a CPU in a multi-purpose or application specific computer or workstation. Control and analysis circuit 168 is coupled to a memory circuit 170 to store programming code for operation of the MRI system 100 and to store the processed image data for later reconstruction, display and transmission. The programming code may execute one or more algorithms that, when executed by a processor, are configured to perform reconstruction of acquired data as described below. In certain embodiments, the memory circuit 170 may store vision transformer models for the techniques described below. In certain embodiments, image reconstruction may occur on a separate computing device having processing circuitry and memory circuitry.

An additional interface circuit 172 may be provided for exchanging image data, configuration parameters, and so forth with external system components such as remote access and storage devices 108. Finally, the system control and analysis circuit 168 may be communicatively coupled to various peripheral devices for facilitating operator interface and for producing hard copies of the reconstructed images. In the illustrated embodiment, these peripherals include a printer 174, a monitor 176, and user interface 178 including devices such as a keyboard, a mouse, a touchscreen (e.g., integrated with the monitor 176), and so forth.

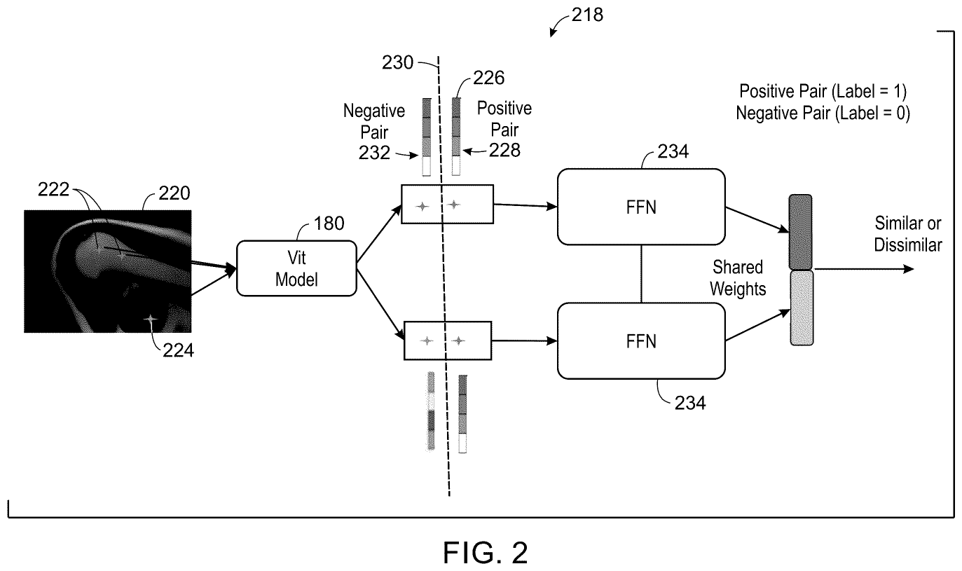

FIG. 2 illustrates a schematic diagram of training (e.g., supervised training) of a contrastive similarity metric learning model 218 for localization. A plurality of medical images are obtained. In certain embodiments, the plurality of medical images are MR images. In certain embodiments, the plurality of medical images may be derived from other types of imaging (e.g., CT imaging). Each medical image is subject to multiple augmentations (e.g., cropping, transformation, rotation, etc.). This enables the contrastive similarity metric learning model 218, upon training, to be robust to variations in real life images. As depicted in FIG. 2, a medical image 220 (representing one of the plurality of medical images) is labeled with areas (e.g., two areas to create positive feature features) within a first region selected and marked (as indicated by reference numeral 222) and an area in a different region (e.g., dissimilar to the first region to create negative feature vectors) selected and marked (as indicated by reference numeral 224). As depicted, the labeling of the medical image 220 is binary. In certain embodiments, the medical image 220 can be labeled with multiple labels. The medical image 220 (along with the augmented versions of the medical image) is inputted into trained vision transformer model 180. The trained vision transformer model 180 outputs both patch level features (e.g., patch level feature vectors) (not shown) and image level features (not shown) from the medical image 220 (and the augmented versions of the medical image). Pixel level features (e.g., pixel level feature vectors) 226 are interpolated from the patch level features.

The pixel level feature vectors 226 are inputted into the contrastive similarity metric learning model 218. The contrastive similarity metric learning model 218 is trained to push similar pixel level feature vectors (e.g., positive pairs such as positive pair 228 on a right side of dotted line 230) as close as possible (e.g., minimize distance in the embedding space) and to push dissimilar pixel level feature vectors (e.g., negative pairs such as negative pair 232 on the left side of the dotted line 230) as apart as possible (e.g., maximize distance in the embedding space). The contrastive similarity metric learning model 218 includes two feed forward neural networks (FFN) 234. The positive pairs are given a weight of 1 and negative pairs are given a label of 0. The two feed forward neural networks 234 have shared weights. The contrastive similarity metric learning model 218 outputs which pixel level feature vectors are similar and pixel level feature vectors are dissimilar.

In certain embodiments, each feed forward neural network 234 has a three layer network (e.g., with 512, 256, and 128 neurons in the respective layers). In certain embodiments, the contrastive similarity metric learning model 218 has a batch size of 64. In certain embodiments, the learning rate of the contrastive similarity metric learning model 218 is 0.01. In certain embodiments, the contrastive similarity metric learning model 218 may utilize a stochastic optimization technique that allows for per-dimension learning rate method for stochastic gradient descent. The variables of the contrastive similarity metric learning model 218 may vary from these.

The contrastive similarity metric learning model 218 as utilized in the present disclosure was trained utilizing 10 medical images and their respective augmentations. In certain embodiments, contrastive similarity metric learning model 218 may be trained on non-medical images (e.g., images for inspection of a part).

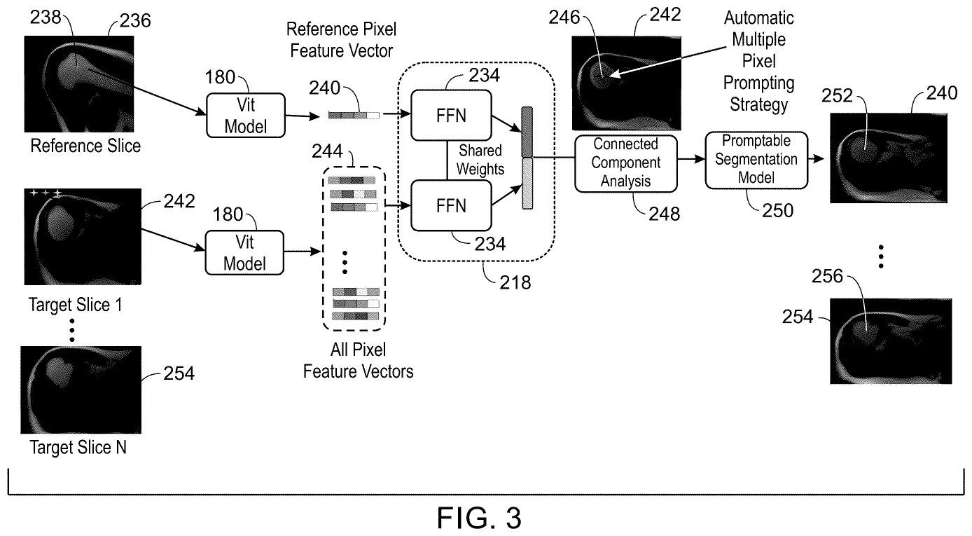

FIG. 3 illustrates a schematic diagram for data adaptive single-shot segmentation with foundation models. FIG. 3 depicts the process for a single task (e.g., localization and segmentation of a single region of interest) but it may be extended for multiple tasks (i.e., localization and segmentations of multiple regions of interest) in a single shot. A template image 236 (e.g., reference slice) is received or obtained that includes a selection of a region of interest within the template image (e.g., selected via user input by a user), wherein the region of interest is marked with a reference marker (as indicated by reference numeral 238) in the template image 236 and is associated with a label. The template image 236 includes one or more anatomical landmarks assigned a respective anatomical label. The template image 236 is an MR image. The template image 236 is inputted into the trained vision transformer model 180. The vision transformer model 180 outputs a reference pixel level feature vector 240 from the region of interest of the template image 236. As depicted, the region of interest is an anatomical landmark. In certain embodiments, the region is of interest is a lesion.

Medical imaging data (e.g., medical imaging volume) acquired of a portion (e.g., shoulder) of a subject is obtained. The medical imaging data includes multiple slices or medical images. The medical imaging data in FIG. 3 is MR imaging data. A medical image 242 (e.g., target slice 1) is inputted into the trained vision transformer model 180. The trained vision transformer model 180 outputs pixel level feature vectors 244 from the medical image 242. The pixel level feature vectors 244 are derived from patch level feature vectors via interpolation. In certain embodiments, the trained vision transformer model 180 also outputs image level features (not shown). The pixel level feature vectors 244 (e.g., all of the pixel level features obtained from the medical image 242) and the reference pixel level feature vector 240 are inputted into the trained contrastive similarity metric learning model 218, wherein the trained contrastive similarity metric learning model 218 is configured to automatically determine which of the pixel level feature vectors 244 are similar to the reference pixel level feature vector 240. The trained contrastive similarity metric learning model 218 outputs the pixel level feature vectors 244 that are similar to the reference pixel level feature vector 240 and the pixel level feature vectors 244 that are dissimilar to the reference pixel level feature vector 240.

Pixels in the medical image 242 associated with the pixel level feature vectors 244 that are similar to the reference pixel level feature vector 240 are labeled with an initial segmentation mask 246, wherein the pixels that are labeled in the medical image 242 correspond to the region of interest (as selected in the template image 236). In certain embodiments, connected component analysis is utilized to label the pixels to generate the initial segmentation mask 246 as indicated by reference numeral 248. The medical image with the initial segmentation mask 246 is inputted into a promptable segmentation model 250. In certain embodiments, the promptable segmentation model 250 is an image segmentation foundation model or generalized segmentation refinement model such as a promptable foundation SAM segmentation model that is configured to refine segmentation for the region of interest. The promptable segmentation model 250 outputs the medical image 242 labeled with a more accurate (e.g., refined) segmentation mask 252 of a region that corresponds to the region of interest. The initial segmentation mask 246 serves as an automatic prompt for labeling.

In certain embodiments, one or more additional medical images 254 (e.g., target slice 254) may be processed in similar manner to medical image 254 to localize and segment the region of interest as depicted in medical image 254 having a respective more accurate segmentation mask 256. In certain embodiments, the process may be utilized on all of the medical image images in an imaging volume of the portion of the subject. In certain embodiments, the process may only be carried out in its entirety on less than an entirety of the medical images in the imaging volume. In particular, in certain embodiments, the most relevant medical images in the imaging volume (i.e., the images closest or most similar to the template image) are processed. In certain images, the respective image level features may be utilized in automatically selecting the most relevant medical images in the imaging volume. In certain embodiments, the data adaptive single-shot segmentation with foundation models may be utilized for localizing and segmenting multiple different regions of interest in the medical imaging data based on multiple and different selections of the different regions of interest on the same template image.

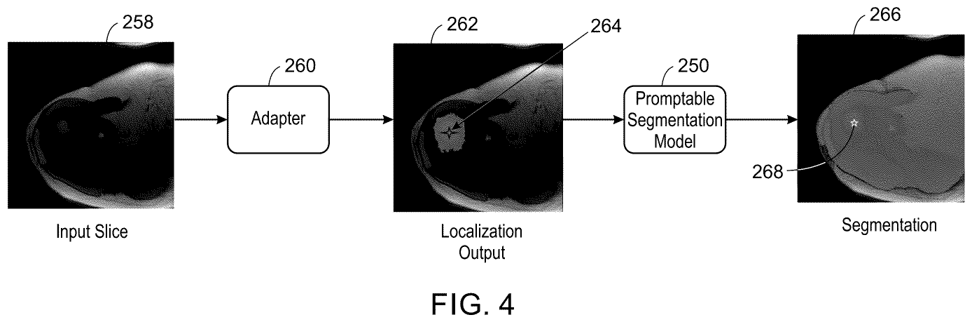

However, data adaptive single-shot segmentation with foundation models described in FIG. 3 only give positive prompts. FIG. 4 depicts the limitations of this approach. As depicted in FIG. 4, an input slice 258 is inputted into an adapter 260 (e.g., contrastive adapter such as the contrastive similarity metric learning model 218 in FIG. 3) resulting in a localization output 262 having a prompting pixel 264 (e.g., positive prompt). The localization output 262 with the prompting pixel 264 is provided to the promptable segmentation model 250. An output image 266 (with segmentation of a region of interest) of the promptable segmentation model 250 has over segmentation due to a lack of appropriate negative prompts. Star 268 on the output image 266 indicates the prompt (positive prompt) derived from the localization output 262.

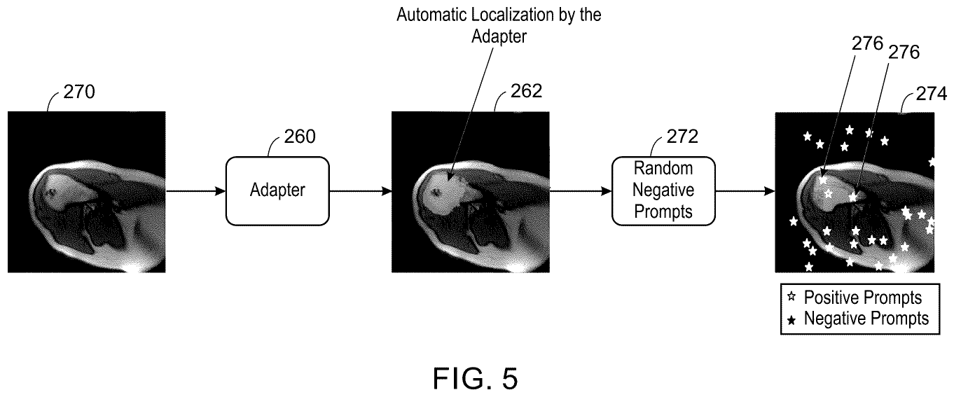

However, randomly choosing negative prompts is not useful. FIG. 5 depicts the issues associated with utilizing randomly chosen negative prompts. As depicted in FIG. 5, an input slice 270 is inputted into an adapter 260 (e.g., contrastive adapter such as the contrastive similarity metric learning model 218 in FIG. 3) resulting in a localization output 262. Random negative prompts are chosen around the automatically localized region as indicated by reference numeral 272. An output image 274 with segmentation has poor segmentation due to negative prompts falling inside the region of interest (as indicated by arrows 276). Since there is a high likelihood that a negative prompt will fall inside the region of interest, randomly choosing negative prompts will result in poor segmentation.

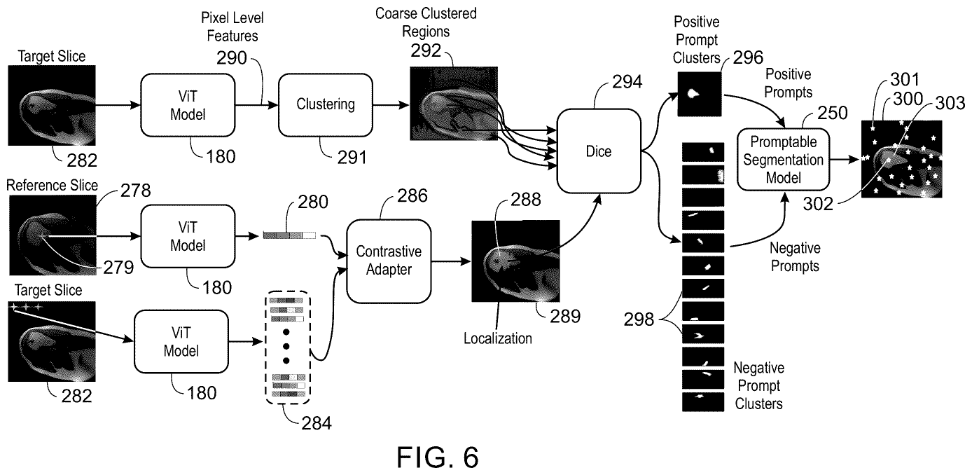

FIG. 6 illustrates an approach to rectify these issues. FIG. 6 illustrates a schematic diagram for task specific prompt generation for few-shot segmentation with foundation models. A template image 278 (e.g., reference slice) is received or obtained that includes a selection of a region of interest within the template image (e.g., selected via user input by a user), wherein the region of interest is marked with a reference marker (as indicated by reference numeral 279) in the template image 278 and is associated with a label. The template image 278 includes one or more anatomical landmarks assigned a respective anatomical label. The template image 278 is an MR image. The template image 278 is inputted into the trained vision transformer model 180. The vision transformer model 180 outputs a reference pixel level feature vector 280 from the region of interest of the template image 278. As depicted, the region of interest is an anatomical landmark. In certain embodiments, the region is of interest is a lesion.

Medical imaging data (e.g., medical imaging volume) acquired of a portion (e.g., shoulder) of a subject is obtained. The medical imaging data includes multiple slices or medical images. The medical imaging data in FIG. 6 is MR imaging data. A medical image 282 (e.g., target slice) is inputted into the trained vision transformer model 180. The trained vision transformer model 180 outputs pixel level feature vectors 284 from the medical image 282. The pixel level feature vectors 284 are derived from patch level feature vectors via interpolation. In certain embodiments, the trained vision transformer model 180 also outputs image level features (not shown). The pixel level feature vectors 284 (e.g., all of the pixel level features obtained from the medical image 282) and the reference pixel level feature vector 280 are inputted into a trained contrastive adapter 286 (e.g., trained contrastive similarity metric learning model), wherein the trained contrastive adapter 286 is configured to automatically determine which of the pixel level feature vectors 284 are similar to the reference pixel level feature vector 280. The trained contrastive adapter 286 outputs the pixel level feature vectors 284 that are similar to the reference pixel level feature vector 280 and the pixel level feature vectors 284 that are dissimilar to the reference pixel level feature vector 280.

Pixels in the medical image 282 associated with the pixel level feature vectors 284 that are similar to the reference pixel level feature vector 280 are labeled with an initial segmentation mask 288 (as shown in output image 289), wherein the pixels that are labeled in the medical image 282 correspond to the region of interest (as selected in the template image 278). In certain embodiments, connected component analysis is utilized to label the pixels to generate the initial segmentation mask 288 as indicated.

As indicated on the top portion of FIG. 6, the medical image 282 (e.g., target slice) is inputted into the trained vision transformer model 180. The trained vision transformer model 180 outputs pixel level feature vectors (as indicated by arrow 290 and the same as the pixel level feature vectors 284) from the medical image 282. The pixel level feature vectors are derived from patch level feature vectors via interpolation. These pixel level feature vectors are subjected to clustering (as indicated by reference numeral 291) to generate different labeled coarse clustered regions in the medical image 282 (as indicated by image 292).

As depicted, identification of regions of overlap (and regions with zero or almost zero overlap) between the different labeled coarse clustered regions (from image 292) and the initial segmentation mask 288 are determined as indicated by reference numeral 294. As depicted, Dice similarity coefficients are utilized for identifying the regions of overlap. In certain embodiments, intersection over union or other technique is utilized for identifying the regions of overlap. As a result of the identification of regions of overlap (and regions with zero or almost zero overlap, automatically generating, via the processing system, both positive prompts based on the regions of overlap and negative prompts based on those regions lacking overlap, positive prompt clusters 296 (task specific positive prompts) and the negative prompt clusters 298 (task specific negative prompts) are automatically generated and provided to (inputted into) the promptable segmentation model 250. In certain embodiments, the promptable segmentation model 250 is an image segmentation foundation model or generalized segmentation refinement model such as a promptable foundation SAM segmentation model that is configured to refine segmentation for the region of interest. The positive prompt clusters 296 and the negative prompt clusters 298 are utilized in refining segmentation of a region in the medical image 282 that corresponds to the region of interest in the template image 278. The promptable segmentation model 250 outputs an image 300 (i.e., the medical image 282 labeled with a more accurate (e.g., refined) segmentation mask 302 of the region that corresponds to the region of interest (with negative prompts 301 and positive prompt 303 indicated).

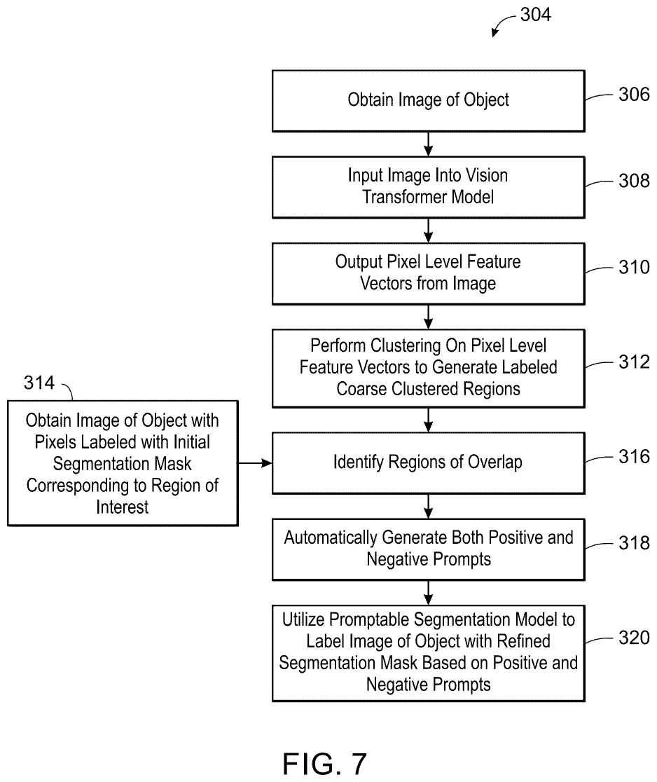

FIG. 7 illustrates a flow diagram of a method 304 for performing task specific prompt generation for few-shot segmentation with foundation models. One or more steps of the method 304 may be performed by processing circuitry of the magnetic resonance imaging system 100 in FIG. 1, processing circuitry of an imaging system of another type (e.g., CT imaging system), or processing circuitry of a separate computing device. One or more of the steps of the method 304 may be performed simultaneously or in a different order from the order depicted in FIG. 7. The method 304 may be utilized for anatomy localization, lesion detection, or other type of application (e.g., medical or non-medical).

The method 304 includes obtaining an image of an object (block 306). In certain embodiments, the image of the object is a medical image of a portion of a subject (e.g., patient). The method 304 also includes inputting the image of the object into a trained vision transformer model (block 308). The method 304 further includes outputting from the trained vision transformer model pixel level feature vectors from the image of the object (block 310). The method 304 further includes performing clustering on the pixel level feature vectors to generate different labeled coarse clustered regions in the image of the object (block 312). The method 304 further includes obtaining the image of the object with pixels labeled with an initial segmentation mask that corresponds to a region of interest in a template image (block 314). The method 304 even further includes identifying regions of overlap between the different labeled coarse clustered regions and the initial segmentation mask (block 316). In certain embodiments, identifying the regions of overlap includes utilizing intersection over union. In certain embodiments, identifying the regions of overlap includes utilizing Dice similarity coefficients. The method 304 further includes automatically generating both positive prompts (task specific positive prompts) based on the regions of overlap and negative prompts (task specific negative prompts) based on those regions lacking overlap (block 318). The positive prompt clusters and the negative prompt clusters are utilized in refining segmentation of a region in the image of the object that corresponds to the region of interest in the template image. The method 304 further includes utilizing a promptable segmentation model to label the image of the object with a refined segmentation mask of the region that corresponds to the region of interest in the template image based on the positive prompt clusters and the negative prompt clusters (block 320).

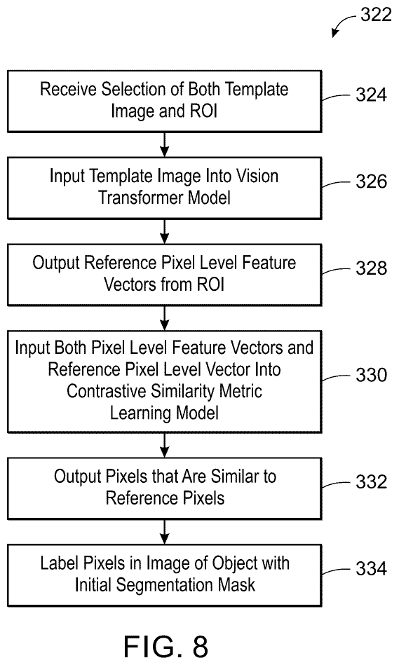

FIG. 8 illustrates a flow diagram of a method 322 for obtaining the image of the object with pixels labeled with an initial segmentation mask that corresponds to a region of interest in a template image as described in block 314 in the method 304 in FIG. 7. One or more steps of the method 322 may be performed by processing circuitry of the magnetic resonance imaging system 100 in FIG. 1, processing circuitry of an imaging system of another type (e.g., CT imaging system), or processing circuitry of a separate computing device. One or more of the steps of the method 322 may be performed simultaneously or in a different order from the order depicted in FIG. 8. The method 322 may be utilized for anatomy localization, lesion detection, or other type of application (e.g., medical or non-medical).

The method 322 includes receiving a selection of both the template image and the region of interest (ROI) within the template image (block 324). The region of interest is marked in the template image and is associated with a label. The method 322 also includes inputting the template image into the trained vision transformer model (block 326). The method 322 further includes outputting from the trained vision transformer model a reference pixel level feature vector from the region of interest of the template image (block 328). The method 322 even further includes inputting, both the pixel level feature vectors and the reference pixel level feature vector into a trained contrastive similarity metric learning model (block 330). The trained contrastive similarity metric learning model is configured to automatically determine which of the pixel level feature vectors are similar to the reference pixel level feature vector. The method 322 further includes outputting from the trained contrastive similarity metric learning model the pixels of the image of object that are similar to reference pixels (block 332). The method 322 includes labeling the pixels in the image of the object associated with the pixel level feature vectors that are similar to the reference pixel level feature vector with the initial segmentation mask (block 334). In certain embodiments, labeling the pixels in the image of the object associated with the pixel level feature vectors that are similar to the reference pixel level feature vector includes utilizing connected component analysis on the pixels to generate the initial segmentation mask.

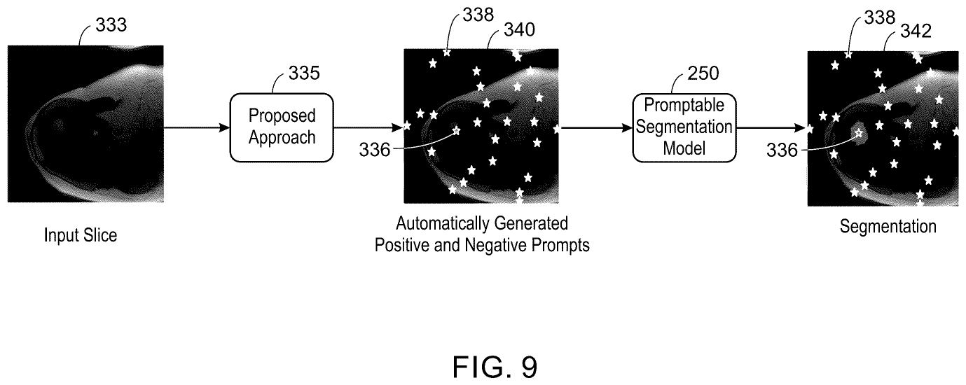

FIG. 9 depicts the results of the method 304 in FIG. 7. As depicted, an input slice 333 (e.g., MR image of shoulder) is subjected to the method 304 (as indicated by reference numeral 335). This in the automatic generation of both positive prompts 336 and negative prompts 338 on an output image 340. The positive prompts 336 and the negative prompts 338 are provided to the promptable segmentation model 250 refines the segmentation of a region of interest in the input slice 333 resulting in image 342 with segmentation of the region of interest with positive prompts 336 and the negative prompts 338.

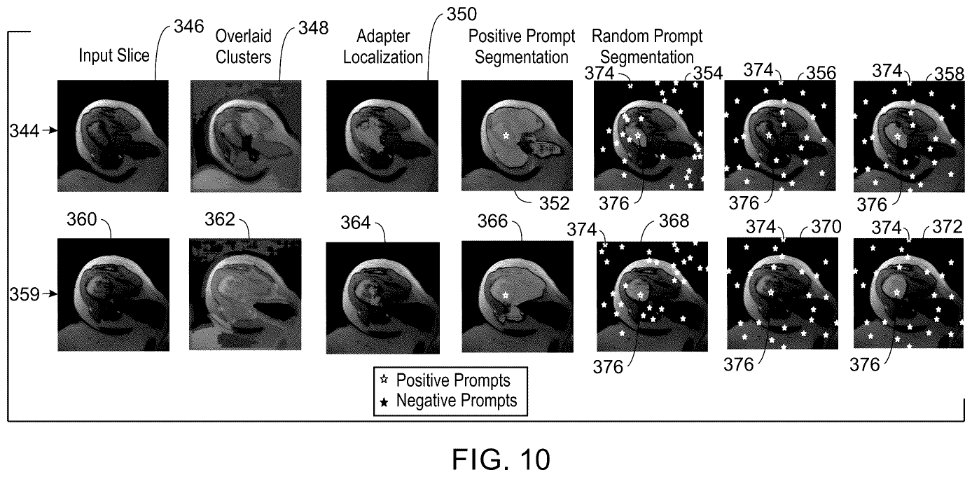

FIG. 10 depicts MR images of a shoulder utilizing different segmentation approaches. A top row 344 of the MR images includes an input slice 346, a corresponding image 348 of the input slice 346 with overlaid clusters, and an image 350 with adapter localization performed on the input slice 346. Image 352 is the output of positive prompt segmentation performed on the input slice 346. Image 354 is the output of random prompt segmentation performed on the input slice 346. Image 356 depicts the negative and positive prompts predicted for the input slice 346 utilizing the method 304 in FIG. 7. Image 358 is the output of the segmentation on the input slice 346 utilizing the method 304 in FIG. 7 (and the predicted negative and positive prompts in image 356). A bottom row 359 of the MR images includes an input slice 360, a corresponding image 362 of the input slice 360 with overlaid clusters, and an image 364 with adapter localization performed on the input slice 360. Image 366 is the output of positive prompt segmentation performed on the input slice 360. Image 368 is the output of random prompt segmentation performed on the input slice 360. Image 370 depicts the negative and positive prompts predicted for the input slice 360 utilizing the method 304 in FIG. 7. Image 372 is the output of the segmentation on the input slice 360 utilizing the method 304 in FIG. 7 (and the predicted negative and positive prompts in image 368). Positive prompts are indicated by reference numeral 374. Negative prompts are indicated by reference numeral 376.

Technical effects of the disclosed subject matter include automatically enabling accurate localization and segmentation using foundation models based on templates. Multiple tasks can be accomplished with a single foundation model (FM). Technical effects of the disclosed subject matter include utilizing the power of SAM-FM to complete the segmentation and achieves this by automatically providing positive and negative prompts based on a user's positive prompt input on few templates (e.g., N=5−10). No retraining of a SAM model is needed with the disclosed embodiments. Technical effects of the disclosed subject matter include providing for faster and pointed annotation of medical imaging data (at a reduced cost).

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method, comprising:
obtaining, via a processing system comprising one or more processors, an image of an object;
inputting, via the processing system, the image of the object into a trained vision transformer model;
outputting, via the processing system, from the trained vision transformer model pixel level feature vectors from the image of the object;
performing, via the processing system, clustering on the pixel level feature vectors to generate different labeled coarse clustered regions in the image of the object;
obtaining, via the processing system, the image of the object with pixels labeled with an initial segmentation mask that corresponds to a region of interest in a template image;
identifying, via the processing system, regions of overlap between the different labeled coarse clustered regions and the initial segmentation mask; and
automatically generating, via the processing system, both positive prompts based on the regions of overlap and negative prompts based on those regions lacking overlap, wherein the positive prompt clusters and the negative prompt clusters are utilized in refining segmentation of a region in the image of the object that corresponds to the region of interest in the template image.

2. The computer-implemented method of claim 1, further comprising utilizing, via the processing system, a promptable segmentation model to label the image of the object with a refined segmentation mask of the region that corresponds to the region of interest in the template image based on the positive prompt clusters and the negative prompt clusters.

3. The computer-implemented method of claim 1, wherein obtaining the image of the object with pixels labeled with the initial segmentation mask comprises:
receiving, via the processing system, a selection of both the template image and the region of interest within the template image, wherein the region of interest is marked in the template image and is associated with a label;
inputting, via the processing system, the template image into the trained vision transformer model;
outputting, via the processing system, from the trained vision transformer model a reference pixel level feature vector from the region of interest of the template image;
inputting, via the processing system, both the pixel level feature vectors and the reference pixel level feature vector into a trained contrastive similarity metric learning model, wherein the trained contrastive similarity metric learning model is configured to automatically determine which of the pixel level feature vectors are similar to the reference pixel level feature vector;
outputting, via the processing system, from the trained contrastive similarity metric learning model the pixels of the image of object that are similar to reference pixels; and
labeling, via the processing system, the pixels in the image of the object associated with the pixel level feature vectors that are similar to the reference pixel level feature vector with the initial segmentation mask.

4. The computer-implemented method of claim 3, wherein labeling the pixels in the image of the object associated with the pixel level feature vectors that are similar to the reference pixel level feature vector comprises utilizing connected component analysis on the pixels to generate the initial segmentation mask.

5. The computer-implemented method of claim 1, wherein the image of the object comprises a medical image of a portion a subject.

6. The computer-implemented method of claim 1, wherein identifying the regions of overlap comprises utilizing intersection over union.

7. The computer-implemented method of claim 1, wherein identifying the regions of overlap comprises utilizing Dice similarity coefficients.

8. A system, comprising:
a memory encoding processor-executable routines; and
a processing system comprising one or more processors and configured to access the memory and to execute the processor-executable routines, wherein the processor-executable routines, when executed by the processing system, cause the processing system to:
obtain an image of an object;
input the image of the object into a trained vision transformer model;
output from the trained vision transformer model pixel level feature vectors from the image of the object;
perform clustering on the pixel level feature vectors to generate different labeled coarse clustered regions in the image of the object;
obtain the image of the object with pixels labeled with an initial segmentation mask that corresponds to a region of interest in a template image;
identify regions of overlap between the different labeled coarse clustered regions and the initial segmentation mask; and
automatically generate both positive prompts based on the regions of overlap and negative prompts based on those regions lacking overlap, wherein the positive prompt clusters and the negative prompt clusters are utilized in refining segmentation of a region in the image of the object that corresponds to the region of interest in the template image.

9. The system of claim 8, wherein the processor-executable routines, when executed by the processing system, further cause the processing system to utilize a promptable segmentation model to label the image of the object with a refined segmentation mask of the region that corresponds to the region of interest in the template image based on the positive prompt clusters and the negative prompt clusters.

10. The system of claim 8, wherein obtaining the image of the object with pixels labeled with the initial segmentation mask comprises:
receiving a selection of both the template image and the region of interest within the template image, wherein the region of interest is marked in the template image and is associated with a label;
inputting the template image into the trained vision transformer model;
outputting from the trained vision transformer model a reference pixel level feature vector from the region of interest of the template image;
inputting both the pixel level feature vectors and the reference pixel level feature vector into a trained contrastive similarity metric learning model, wherein the trained contrastive similarity metric learning model is configured to automatically determine which of the pixel level feature vectors are similar to the reference pixel level feature vector;
outputting from the trained contrastive similarity metric learning model the pixels of the image of object that are similar to reference pixels; and
labeling the pixels in the image of the object associated with the pixel level feature vectors that are similar to the reference pixel level feature vector with the initial segmentation mask.

11. The system of claim 10, wherein labeling the pixels in the image of the object associated with the pixel level feature vectors that are similar to the reference pixel level feature vector comprises utilizing connected component analysis on the pixels to generate the initial segmentation mask.

12. The system of claim 8, wherein the image of the object comprises a medical image of a portion a subject.

13. The system of claim 8, wherein identifying the regions of overlap comprises utilizing intersection over union.

14. The system of claim 8, wherein identifying the regions of overlap comprises utilizing Dice similarity coefficients.

15. A non-transitory computer-readable medium, the computer-readable medium comprising processor-executable code that when executed by a processing system comprising one or more processors, causes the processing system to:
obtain an image of an object;
input the image of the object into a trained vision transformer model;
output from the trained vision transformer model pixel level feature vectors from the image of the object;
perform clustering on the pixel level feature vectors to generate different labeled coarse clustered regions in the image of the object;
obtain the image of the object with pixels labeled with an initial segmentation mask that corresponds to a region of interest in a template image;
identify regions of overlap between the different labeled coarse clustered regions and the initial segmentation mask; and
automatically generate both positive prompts based on the regions of overlap and negative prompts based on those regions lacking overlap, wherein the positive prompt clusters and the negative prompt clusters are utilized in refining segmentation of a region in the image of the object that corresponds to the region of interest in the template image.

16. The non-transitory computer-readable medium of claim 15, wherein the processor-executable code, when executed by the processing system, further causes the processing system to utilize a promptable segmentation model to label the image of the object with a refined segmentation mask of the region that corresponds to the region of interest in the template image based on the positive prompt clusters and the negative prompt clusters.

17. The non-transitory computer-readable medium of claim 15, wherein obtaining the image of the object with pixels labeled with the initial segmentation mask comprises:
receiving a selection of both the template image and the region of interest within the template image, wherein the region of interest is marked in the template image and is associated with a label;
inputting the template image into the trained vision transformer model;
outputting from the trained vision transformer model a reference pixel level feature vector from the region of interest of the template image;
inputting both the pixel level feature vectors and the reference pixel level feature vector into a trained contrastive similarity metric learning model, wherein the trained contrastive similarity metric learning model is configured to automatically determine which of the pixel level feature vectors are similar to the reference pixel level feature vector;
outputting from the trained contrastive similarity metric learning model the pixels of the image of object that are similar to reference pixels; and
labeling the pixels in the image of the object associated with the pixel level feature vectors that are similar to the reference pixel level feature vector with the initial segmentation mask.

18. The non-transitory computer-readable medium of claim 17, wherein labeling the pixels in the image of the object associated with the pixel level feature vectors that are similar to the reference pixel level feature vector comprises utilizing connected component analysis on the pixels to generate the initial segmentation mask.

19. The non-transitory computer-readable medium of claim 15, wherein the image of the object comprises a medical image of a portion a subject.

20. The non-transitory computer-readable medium of claim 15, wherein identifying the regions of overlap comprises utilizing intersection over union or utilizing Dice similarity coefficients.
